(19) United States
(12) Patent Application Publication
(10) Pub. No.: US 2026/0237207 A1
(43) Pub. Date: Aug. 13, 2026

(54) SYSTEMS AND METHODS OF USING ARTIFICIAL INTELLIGENCE TO UNDERSTAND VIDEO CONTENT

(71) Applicant: Cynapse Pte Ltd., Singapore (SG)

(72) Inventors: Prabodh Tripathi, Singapore (SG); Ng Wen Terence, Singapore (SG); Guy Ron, Singapore (SG); Gan Zhen Yang, Singapore (SG); Pierce Ng Wei Sheng, Singapore (SG); Noam Berda, Singapore (SG); llly Ayelet Gruber, Singapore (SG)

(21) Appl. No.: 19/368,802

(22) Filed: Oct. 24, 2025

Related U.S. Application Data
(63) Continuation-in-part of application No. 19/309,435, filed on Aug. 25, 2025.
Application No. 19/309,435 is a continuation-in-part of application No. 19/231,267, filed on Jun. 6, 2025.
Application No. 19/231,267 is a continuation-in-part of application No. 19/231,199, filed on Jun. 6, 2025.
Application No. 19/231,199 is a continuation of application No. 19/223,940, filed on May 30, 2025.
Application No. 19/223,940 is a continuation-in-part of application No. 18/981,227, filed on Dec. 13, 2024.
Application No. 19/309,435 is a continuation-in-part of application No. 19/039,719, filed on Jan. 28, 2025.
Application No. 19/039,719 is a continuation-in-part of application No. 18/981,227, filed on Dec. 13, 2024.

(51) Int. Cl. G06V 20/40; G06V 10/82; G06V 20/70; G06V 30/262

(52) U.S. Cl. CPC G06V 20/41; G06V 10/82; G06V 20/46; G06V 20/70; G06V 30/262

(57) ABSTRACT

Systems and methods are disclosed for orchestrating multimodal query based on video content using a reasoning orchestrator configured to interpret natural language queries and activate specialized agents and tools. A scene understanding module processes video streams in real-time and generates a continuously updated detailed frame document comprising structured metadata, semantic embeddings, and contextual annotations. A planning agent determines which agents or tools are appropriate based on the query and the contents of the frame document. The orchestrator activates the selected agents or tools, receives intermediate outputs, and generates a multimodal response. The system supports adaptive planning, dynamic key frame selection, and integration of structured and unstructured data sources, including annotated video, statistical analysis, and document-aware synthesis. The disclosed architecture enables scalable, context-aware orchestration of agents for real-time surveillance, investigation, and semantic query resolution.

This application claims priority to and is a continuation-in-part of U.S. patent application Ser. No. 19/309,435 filed Aug. 25, 2025, which claims priority to and is a continuation-in-part of U.S. patent application Ser. No. 19/231,267 filed Jun. 6, 2025, which claims priority to and is a continuation-in-part of U.S. patent application Ser. No. 19/231,199 filed Jun. 6, 2025, which claims priority to and is a continuation of U.S. patent application Ser. No. 19/223,940 filed May 30, 2025, and claims priority to and is a continuation-in-part of U.S. patent application Ser. No. 19/039,719 filed Jan. 28, 2025, both of which claim priority to and are continuations-in-part of U.S. patent application Ser. No. 18/981,227 filed Dec. 13, 2024. All extrinsic materials identified in this application are incorporated by reference in their entirety.

### FIELD OF THE INVENTION

The field of invention is artificial intelligence, and more particularly, systems and methods for coordinating computational agents and tools to process multimodal data and resolve queries across dynamic and heterogeneous information sources.

### BACKGROUND

The background description includes information that may be useful in understanding the present invention. It is not an admission that any of the information provided in this application is prior art or relevant to the presently claimed invention, or that any publication specifically or implicitly referenced is prior art.

Multimodal artificial intelligence systems have gained traction in recent years, particularly in the context of question answering, content generation, and enterprise automation. Several prior art references disclose systems that attempt to address aspects of these domains, yet they fall short in providing a unified, scalable, and context-aware orchestration framework capable of coordinating specialized agents and tools in response to natural language queries—particularly in implementations that process real-time video content.

For example, Sumedh Rasal et al., Navigating Complexity: Orchestrated Problem Solving with Multi-Agent LLMs, arXiv:2402.16713v2 [cs. MA] (Jul. 10, 2024) describes a multi-agent architecture in which an orchestrating large language model (LLM) decomposes complex problems into subproblems and assigns them to specialized agents. But the reference fails to disclose a reasoning orchestrator configured to interpret incoming queries in the context of structured metadata, semantic embeddings, and contextual annotations derived from live video streams. It does not describe a planning agent capable of sequencing tool activation based on query type, system resource availability, or scene complexity. Nor does it disclose any mechanism for integrating multimodal triggers or adapting orchestration logic based on intermediate outputs.

Krishna Singh Rajput et al., Rethinking Information Synthesis in Multimodal Question Answering: A Multi-Agent Perspective, arXiv:2505.20816v1 [cs. CL] (May 27, 2025) describes a system where different agents focus on gathering information from text, tables, and images. These agents then combine what they find to help answer complex questions. Although this approach makes it easier to understand how answers are formed, it does not include a central coordinator that can break down the meaning of questions and activate the right tools based on a set of rules and system limits. The system also does not explain how to organize agents to respond to changing details from live video feeds.

U.S. Pat. No. 12,111,859 to Siebel et al. discloses an enterprise generative artificial intelligence architecture comprising orchestrators, agents, and tool modules configured to retrieve and process structured and unstructured data. But the orchestrator described therein is limited to routing inputs and lacks layered reasoning capabilities. The reference does not disclose a reasoning orchestrator capable of interpreting natural language queries, generating structured investigation plans, or adapting tool sequencing based on real-time feedback. It does not describe a planning agent configured to construct dynamic workflows using, e.g., decision trees, rule-based templates, or logic generated by a large language model. Nor does it disclose any orchestration system capable of coordinating specialized agents in response to semantic annotations derived from key frames selected from live video feeds.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

It has yet to be appreciated that a reasoning orchestrator can serve as a central coordination layer that interprets natural language queries, activates specialized tools and agents based on contextual constraints, and dynamically adapts its planning logic in response to real-time feedback. There remains a need for systems and methods that enable scalable, interpretable, and context-aware orchestration of multimodal AI agents capable of performing complex reasoning, synthesis, and generation tasks across structured and unstructured data sources, including live video streams.

### SUMMARY OF THE INVENTION

In one aspect, a method of orchestrating multimodal query resolution for queries about video content that is processed in real-time comprises the steps of: receiving a query at an input interface; determining, by a planning agent, one or more tools or sub-agents to activate based on the query and schema of a detailed frame document; wherein the detailed frame document comprises structured and contextualized information about the video content and is continuously updated as the video content is processed in real-time; wherein the one or more tools or sub-agents are activated based on the query and on a specialization of each activated tool or sub-agent; accessing the detailed frame document by the one or more tools or sub-agents to generate outputs based on the query; receiving, by a response generator, outputs from the activated tools or sub-agents; and generating, by the response generator, a response to the query based on the outputs from the one or more tools or sub-agents.

In some embodiments, the input interface comprises a graphical user interface, an API endpoint, or a natural language processing module. The detailed frame document can include structured metadata, semantic embeddings, and contextual annotations derived from key frames of the video content. The document may be generated by a scene understanding module that selects key frames based on temporal sampling, object motion analysis, or scene activity density.

In some embodiments, the planning agent sequences activation of the tools or sub-agents based on system resource availability or scene complexity. Tool activation can also be adapted in real-time based on intermediate outputs or evolving scene context. The tools or sub-agents can include a search tool, an analysis tool, a graph generation tool, a summarization tool, an investigation tool, or a document-aware question answering tool.

In some embodiments, the response generator is configured to produce responses in multiple formats. These responses can include annotated video segments, graphical visualizations, and downloadable reports.

In another aspect, a method of orchestrating multimodal query resolution for video content processed in real-time comprises the steps of: receiving, by a reasoning orchestrator, a natural language query at an input interface; interpreting, by the reasoning orchestrator, the natural language query in the context of detailed frame document schema; generating, by the reasoning orchestrator, a structured investigation plan that identifies one or more specialized tools or sub-agents to activate based on the query and the detailed frame document; activating, by the reasoning orchestrator, the one or more specialized tools or sub-agents according to the structured investigation plan; receiving, by the reasoning orchestrator, outputs from the activated tools or sub-agents; and generating, by the reasoning orchestrator, a response to the query based on the outputs.

In some embodiments, the structured investigation plan is dynamically adapted based on intermediate outputs from the specialized tools or sub-agents. The plan can be constructed using a decision tree, a rule-based template, or logic generated by a large language model. The reasoning orchestrator can maintain a contextual memory of prior queries to refine selection of tools or sub-agents.

In some embodiments, the response generated by the reasoning orchestrator includes annotated video, graphical visualizations, or downloadable reports. The detailed frame document can include structured metadata, semantic embeddings, and contextual annotations derived from key frames of the video content. The specialized tools or sub-agents can include a search tool, an analysis tool, a graph generation tool, a summarization tool, an investigation tool, or a document-aware question answering tool.

In another aspect, a method of orchestrating multimodal query resolution for real-time video content comprises the steps of: receiving, by a reasoning orchestrator, a query or an external trigger at an input interface; interpreting, by the reasoning orchestrator, the query or trigger in the context of a continuously updated detailed frame document comprising structured metadata, semantic embeddings, and contextual annotations; determining, by the reasoning orchestrator, one or more specialized tools or sub-agents to activate based on the query or trigger and the contents of the detailed frame document; activating, by the reasoning orchestrator, the one or more specialized tools or sub-agents; receiving, by the reasoning orchestrator, outputs from the activated tools or sub-agents; and generating, by the reasoning orchestrator, a multimodal response to the query or trigger based on the outputs.

In some embodiments, the external trigger comprises an anomaly detected in a video feed, an emergency call, or a document upload. The multimodal response generated by the reasoning orchestrator can include an alert generated in response to the trigger. Tool activation can be adapted in real-time based on evolving scene context. The specialized tools or sub-agents can include a document-aware question answering tool configured to process external documents or images uploaded via the input interface.

One should appreciate that the disclosed subject matter provides many advantageous technical effects including enabling real-time, multimodal query resolution for video content while dynamically adapting tool activation based on scene complexity or system resource availability. This approach also facilitates the generation of rich, context-aware responses in multiple formats, such as annotated video segments, graphical visualizations, and downloadable reports. It should also be appreciated that the systems and methods of the inventive subject matter do not depend on fixed tool sequences or static investigation plans, but instead allow for flexible, context-driven orchestration of specialized tools and sub-agents.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 illustrates a scene understanding module configured to generate a detailed frame document from selected key frames of a video stream.

FIG. 2 illustrates the architecture of a smart surveillance system having a reasoning orchestrator that features an input interface, a planning agent, tools/sub-agents, and a response generator.

FIG. 3 illustrates a search tool configured to retrieve relevant information from a database based on natural language queries.

FIG. 4 illustrates an analysis tool configured to perform statistical computations over retrieved data.

FIG. 5 illustrates a graph generation tool configured to visualize statistical outputs.

FIG. 6 illustrates a summarization tool configured to generate textual summaries based on user queries.

FIG. 7 illustrates an investigation tool configured to perform event-specific investigations based on internal or external triggers.

FIG. 8 illustrates a document-aware question answering tool configured to process external documents and images to enhance query context.

FIG. 9 illustrates a user defined alert tool configured to generate alerts based on a query.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

The present disclosure relates to a smart surveillance system configured to perform multimodal information retrieval, statistical analysis, contextual summarization, and video analytics on video streams (e.g., live and prerecorded video). The system comprises a reasoning orchestrator having an input interface, a planning agent, a set of specialized tools and sub-agents, and a response generator. A scene understanding module generates a real-time updated detailed frame documents having information about a video, and the detailed frame document is used by the reasoning orchestrator to respond to queries. The architecture is designed to support real-time, context-aware query resolution using structured and unstructured data derived from a detailed frame document generated by the scene understanding module tasked with analyzing a video stream.

In preferred embodiments, the scene understanding module is configured to operate on a stream of dynamically selected key frames extracted from one or more incoming video feeds. Rather than processing every frame in the stream—which would impose significant computational demands—the system employs a frame preprocessing module that selects key frames based on a combination of temporal sampling, object motion analysis, scene activity density, and domain-specific heuristics. These heuristics may include predefined thresholds for object velocity, frequency of interactions, or the presence of contextually relevant entities (e.g., vehicles, pedestrians, or anomalous behaviors). The selection process ensures that a subset of total frames (e.g., frames containing meaningful or actionable content) are forwarded to the scene understanding module, thereby optimizing resource utilization without sacrificing contextual fidelity.

Upon receiving a key frame, the scene understanding module initiates a three-tiered processing pipeline. The first tier performs object-level analysis, identifying and classifying entities within the frame using trained detection models. The second tier applies vectorization techniques via a Vision-Language Model (VLM), converting visual features into structured embeddings that capture semantic relationships among detected entities. The third tier employs a Vision Large Language Model (VLLM) to generate contextual descriptions that integrate spatial, temporal, and semantic cues, resulting in a rich contextual description of the scene.

As used herein, the term “frame document schema” refers to a database schema that specifies the fields, types, and relationships for detailed frame documents generated by the scene understanding module and stored in a database. The planning agent accesses only the schema to select tools/sub-agents. Whether particular data values exist (e.g., whether red cars were seen today) is determined only after a tool/sub-agent issues a database query. By keeping the planning agent separate from the detailed frame documents, the system operates more efficiently by reducing unnecessary database queries. This also reduces the risk of exposing sensitive information. Thus, the planning agent works with schema of frame documents and relies on the tools/sub-agents to do the work of retrieving information from detailed frame documents themselves.

The planning agent can implement robust guardrails designed to prevent the execution of malicious or out-of-domain user queries, thereby safeguarding the integrity and security of the system. These guardrails may include mechanisms that block requests attempting to delete or modify database records, as well as filters that detect and reject queries unrelated to the system's intended operational scope—such as questions about external topics that are unrelated to any aspect of a given video (e.g., a query asking “who is the current President of the United States” when the video comprises surveillance footage from a dock). Mechanisms for implementing guard rails in a planning agent can be, e.g., rule based, heuristic, and AI intent classifiers. By parsing each incoming query and evaluating it against a predefined set of permissible actions and domains, the planning agent ensures that only valid, relevant queries are processed. This approach not only protects sensitive data from unauthorized manipulation but also maintains the focus and reliability of the surveillance system's query-handling capabilities.

The output of this pipeline is a detailed frame document comprising structured metadata, vectorized representations, and contextual annotations. The terms semantic embeddings, vectorized representations, and contextual annotations can be used interchangeably to mean the same thing. Detailed frame documents are stored in a database and as discussed above, are not necessarily directly accessed by the planning agent. Instead, the planning agent accesses only a frame document schema that describes the fields and relationships of the stored detailed frame documents and uses this schema to plan tool/sub-agent selection. By limiting processing to key frames and leveraging high-efficiency AI models, the system achieves real-time performance in environments where full-frame analysis would otherwise be computationally prohibitive. This architecture enables continuous monitoring, semantic interpretation, and responsive query handling across diverse operational domains, including traffic surveillance, public safety, and autonomous incident reporting.

In especially preferred embodiments, the key frame selection process is adaptive and context-aware, allowing the system to dynamically adjust sampling rates based on scene complexity, system load, and user-defined priorities. For example, in high-traffic environments, the system may increase sampling frequency during peak hours or in response to detected anomalies, such as sudden crowd formation or erratic vehicle behavior. Conversely, in low-activity periods, the system may reduce sampling to conserve resources while maintaining baseline situational awareness. This adaptive strategy further enhances the scalability and responsiveness of the scene understanding module, making it suitable for deployment in both edge and cloud-based infrastructures.

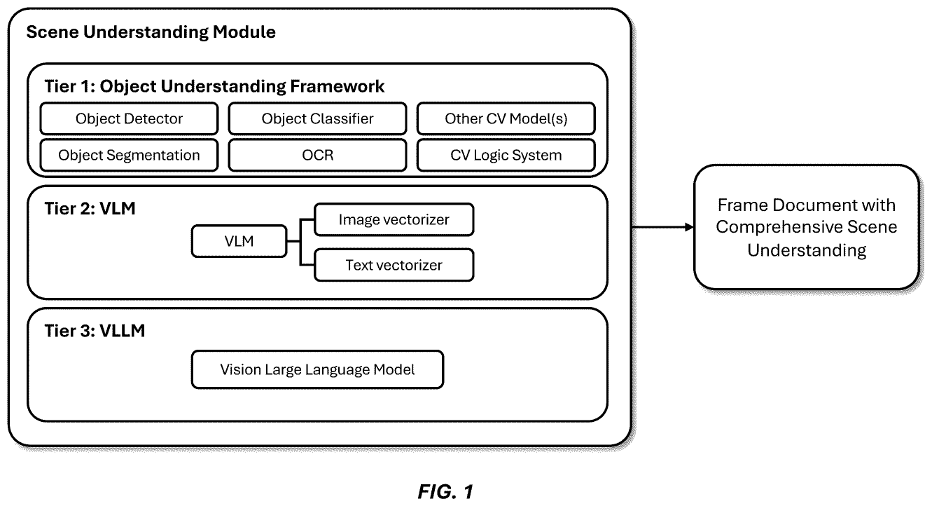

FIG. 1 illustrates a scene understanding module configured to generate a detailed frame document from selected key frames of a video stream. The module is organized into a three-tiered architecture that enables real-time contextual interpretation of video content while mitigating the high computational demands typically associated with deep learning models.

Tier 1 comprises an object understanding framework responsible for low-level visual analysis. This tier includes an object detector that identifies entities such as vehicles, people, and signage within the frame; an object classifier that assigns semantic labels to detected entities; and an object segmentation component that delineates boundaries and regions of interest. An OCR processor extracts textual information embedded in the scene, such as license plates or signage, while a computer vision logic system integrates these outputs to generate structured metadata describing the visual content. Collectively, Tier 1 transforms raw pixel data into a set of annotated visual primitives suitable for higher-level reasoning.

Tier 2 applies a VLM that functions as both an image vectorizer and a text vectorizer. The VLM receives the structured outputs from Tier 1 and encodes them into semantic embeddings that capture relationships among visual and textual elements. These vectorized representations serve as a bridge between low-level perception and high-level contextual synthesis, enabling the system to reason about scene composition, entity interactions, and temporal dynamics.

Tier 3 employs a VLLM to generate a contextual description of the scene. This model integrates the semantic embeddings produced by the VLM with spatial and temporal cues to produce a coherent contextual description of the frame. The output includes contextual annotations that describe not only what is present in the scene, but also how entities relate to one another and to the broader environment.

The resulting detailed frame document produced by the scene understanding module includes structured metadata, vectorized representations, and contextual descriptions. These continuously updated detailed frame documents are stored in a database. Queries (e.g., natural language user queries) are input into the input interface and passed to the planning agent, and the planning agent can then interpret user queries in view of the frame document schema and select/sequence tools/sub-agents. The tools/sub-agents can then query the database to retrieve and process one or more detailed frame documents. The response generator can then compile outputs from the tools/sub-agents into multimodal responses.

Thus, the planning agent can feature a query parser that convert a natural language query to a database query that can facilitate hybrid searches such as structured and unstructured searches. Thus, the database stores both structured information (e.g., detection/classification labels, event types, timestamps, segmentation regions, object proximity and durations) and unstructured information in the form of image vectors (embeddings) derived from object crops or frames.

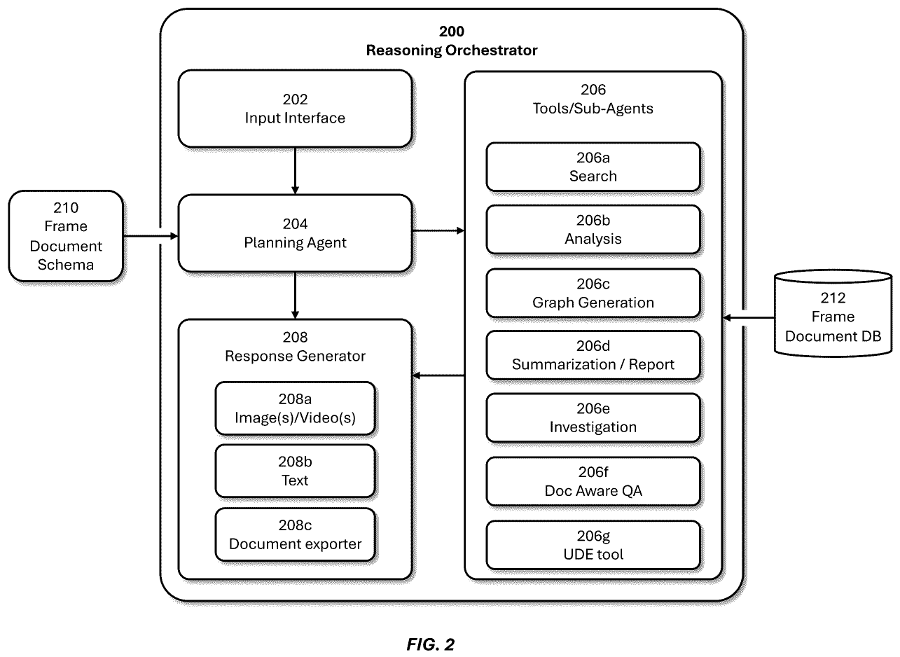

FIG. 2 illustrates the architecture of the smart surveillance system comprising a reasoning orchestrator 200 having an input interface 202, a planning agent 204, a set of tools and sub-agents 206, and a response generator 208. The system is configured to receive natural language queries, determine appropriate processing pathways, activate relevant tools, and generate structured responses in multiple formats.

The input interface 202 may be implemented as a graphical user interface, an API endpoint, or another input mechanism through which queries are submitted. In some embodiments, the input may be provided by a user, while in others it may be provided by a large language model (LLM) acting autonomously or in response to external triggers. The input interface 202 supports queries, document uploads, alert configurations, and other forms of interaction.

The input interface is designed to accept any combination of input types, enabling users to submit natural language queries, upload documents, and provide images or video segments—either individually or together—for analysis. This versatile capability allows the system to process requests that may include text questions, incident reports, multimedia evidence, or a mix of these, ensuring comprehensive support for a wide range of surveillance and investigative scenarios. Additionally, the interface can handle structured data forms and user-defined alerts, allowing users to combine these inputs as needed to suit different operational contexts.

Systems and methods of the inventive subject matter can also be configured to support follow-up queries, enabling users to engage in conversational or iterative interactions. After submitting an initial query, users can input subsequent queries that reference, refine, or build upon previous requests. These follow-up queries may pertain to clarifying details, requesting additional information, or narrowing the scope of results from earlier queries. The system maintains contextual awareness of the query history, allowing the planning agent to interpret the intent and relevance of each follow-up in relation to prior interactions. This capability facilitates dynamic investigative workflows, where users can continuously explore, analyze, and extract insights from the surveillance data through a sequence of related queries, ensuring a seamless and responsive user experience.

In some embodiments, the planning agent can employ a hybrid decision logic framework comprising one or more of rule-based logic, heuristic mappings, and AI-driven intent classification. Rule-based logic may be used to handle deterministic query types, such as structured database lookups or predefined alert conditions. Heuristic mappings enable the orchestrator to associate query patterns with tool capabilities based on historical usage and domain-specific templates. In some embodiments, the planning agent incorporates a fine-tuned large language model (LLM) that performs semantic parsing and intent recognition, allowing the system to interpret complex or ambiguous queries. The planning agent may also maintain a query history and contextual memory, enabling it to refine tool selection based on prior interactions, user preferences, or operational constraints.

Upon receiving input, the input interface 202 forwards the query from the input interface to the planning agent 204, which analyzes the query's intent, context, and available system resources. The planning agent 204 then determines which tools or sub-agents should be activated to fulfill the query and sequences their execution accordingly. These determinations can be made using information from a detailed frame document that the query relates to, as well.

The planning agent operates downstream of the reasoning orchestrator and is responsible for sequencing tool activation and managing multi-step processing workflows. In scenarios involving investigations, the planning agent generates structured investigation plans that define the sequence, scope, and conditional logic for tool execution. These plans may be constructed using decision trees, rule-based templates, or dynamically generated workflows produced by a fine-tuned LLM. For example, in response to a query such as “Investigate all persons loitering near vehicle X for more than 10 minutes,” the planning agent may activate the search tool to identify relevant frames, the investigation tool to track subjects, and the summarization tool to compile findings. The planning agent monitors intermediate outputs and adapts the investigation plan in real time based on system feedback, resource availability, and evolving scene context. This adaptive planning capability enables the system to respond intelligently to complex queries, optimize resource usage, and maintain operational continuity across diverse surveillance scenarios.

Upon generation of the detailed frame document by the scene understanding module, the document is stored to a database where it is continuously updated. The planning agent is configured to interpret incoming user queries in the context of frame document schema, which features information about the type of data in the detailed frame document but not the data itself. This enables the planning agent to determine which tools or sub-agents are most appropriate for fulfilling the query, and/or to sequence their activation accordingly.

The planning agent performs semantic parsing of the query, evaluates its intent, and cross-references the query constraints with the contents of the detailed frame document. For example, if the query references specific entities, behaviors, or temporal conditions, the planning agent identifies relevant annotations and metadata within the frame document to guide tool selection. This context-aware interpretation ensures that tool activation is both precise and efficient, reducing unnecessary computation and improving response relevance.

The tools and agents 206 include six specialized modules, each configured to perform a distinct computational task. These include a search tool, an analysis tool, a graph generation tool, a summarization/report tool, an investigation tool, a document-aware QA tool, and a UDE (user defined alert) tool. Each tool is described in detail in the following figures.

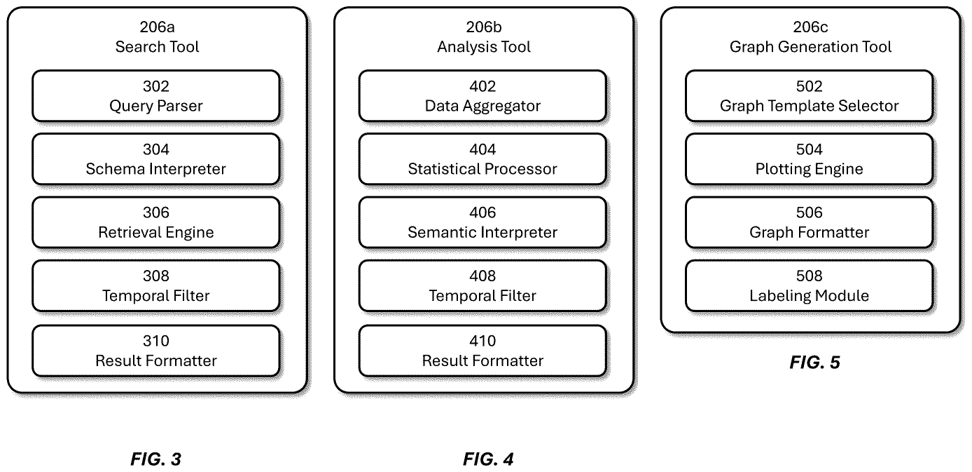

FIG. 3 illustrates the architecture of the search tool 206a, which is configured to retrieve relevant information from a database (e.g., from the detailed frame document that is stored in the database) based on natural language queries. The search tool 206a includes a query parser 302, a schema interpreter 304, a temporal filter 308, and a result formatter 310.

The planning agent 204 selects the search tool 206a when the input interface receives queries that require semantic retrieval of visual or metadata content. For example, queries such as “Find red cars involved in illegal parking last week,” “Search for cars with dented bumpers,” “Find fighting incidents last month where one of the involved persons was wearing a black hoodie,” or “Find a truck that has the text ‘FAIRVIEW TRADING’ on it” indicate a need for structured access to annotated video and image data. The query parser 302 converts natural language into structured database queries, while the schema interpreter 304 maps query terms to fields in the database schema. Query parser 302 can thus convert natural language into a database query capable of hybrid search that combines structured filtering (e.g., by color, type, violation, time) with vector similarity over the stored embeddings. For example, a query such as “find red vehicles with chocolate advertisement involved in illegal parking” first filters for red vehicles with the specified violation and then performs a vector similarity search over the vehicle crops to match the “chocolate advertisement” concept. The retrieval engine 306 executes the query and accesses information in the detailed frame document from stored in the database. Search tool 206a can also feature a temporal filter that enables the tool to isolate and retrieve records based on user-specified time constraints, supporting queries such as “search for cars with dented bumpers last weekend. The result formatter 310 packages the results—including image paths, video segments, and semantic annotations—so they can be used by the response generator 208.

Thus, the search tool 206a receives natural language queries parsed by the query parser 302, along with schema mappings from the schema interpreter 304 and metadata from the detailed frame document. It generates structured query results including image paths, video segments, and semantic annotations, which are formatted by the result formatter 308 and returned to the response generator 208.

FIG. 4 depicts the analysis tool 206b, which performs statistical computations over data retrieved from the database. The analysis tool 206b includes a data aggregator 402, a statistical processor 404, a semantic interpreter 406, and a temporal filter 408.

The planning agent 204 activates the analysis tool 206b when the input interface receives queries involving numerical insights or performance metrics. For instance, queries such as “What was the number of different types of violations detected last week?”, “Which location saw the most fighting incidents last weekend?”, “What was the average speed of vehicles at location X during nighttime on Oct. 5, 2025?”, or “Give me the number of different kinds of vehicles detected last week during working hours” require temporal filtering and statistical computation. The data aggregator 402 collects relevant records based on query parameters. The statistical processor 404 computes metrics such as counts, averages, distributions, and correlations. The semantic interpreter 406 maps raw data to meaningful categories using labels and annotations from the detailed frame document. The temporal filter 408 isolates data based on time constraints.

Thus, the analysis tool 206b accepts retrieved data records, temporal constraints, and semantic labels derived from the detailed frame document. It produces aggregated metrics such as counts, averages, distributions, and interpreted statistical summaries, using the data aggregator 402, statistical processor 404, semantic interpreter 406, and temporal filter 408.

FIG. 5 shows the graph generation tool 206c. The graph generation tool 206c includes a graph template selector 502, a plotting engine 504, a graph formatter 506, and a labeling module 508.

The planning agent 204 selects the graph generation tool 206c when the input interface includes requests for visual representations of data. Queries such as “Plot a bar graph showing the number of violations of each kind last week,” “Create a pie chart showing the different kinds of vehicles detected performing illegal U-turns during peak hours,” or “Create a graph showing the trend of the number of violations each day for the last 1 month” prompt this selection. The graph template selector 502 determines the appropriate visualization format based on the query. The plotting engine 504 renders the graph using statistical data. The graph formatter 506 applies layout and styling, while the labeling module 508 annotates the graph with legends, data values, and semantic tags.

Thus, the graph generation tool 206c receives visualization parameters derived from the query along. It generates graphical visualizations including bar charts, pie charts, and trend graphs, using the graph template selector 502, plotting engine 504, graph formatter 506, and labeling module 508.

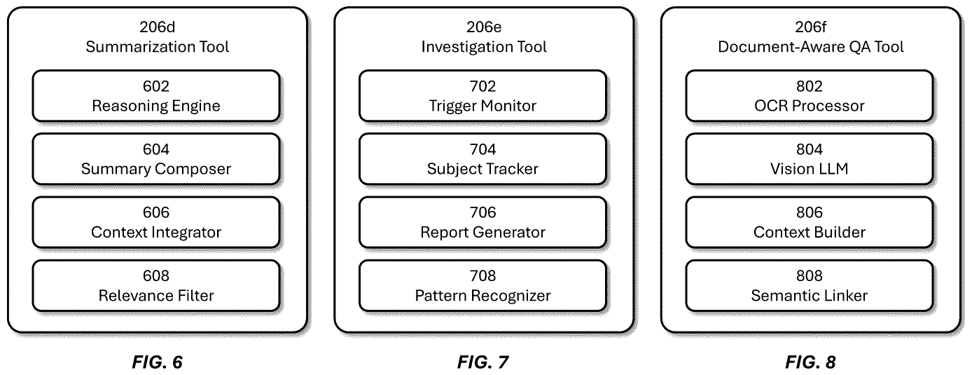

FIG. 6 illustrates the summarization/report tool 206d, which generates textual summaries based on user queries. The summarization tool 206d includes a reasoning engine 602, a summary composer 604, a context integrator 606, and a relevance filter 608.

The planning agent 204 activates the summarization tool 206d when the input interface receives queries requiring narrative synthesis or contextual reporting. For example, “Summarize what happened in the past 24 hours,” “Give a summary of illegal parking violations,” “Summarize different types of alerts, their numbers, and their locations in the past 24 hours,” or “Write a summary of fighting violations in the past 1 week, focusing on those lasting longer than 30 seconds and involving multiple people” indicate a need for high-level abstraction. The reasoning engine 602 determines which data to include based on user intent and available context, which can be determined based on the user query. The summary composer 604 generates natural language output. The context integrator 606 incorporates external documents, prior queries, and scene-level annotations. The relevance filter 608 ensures that only pertinent information is included in the final summary.

Thus, the summarization/report tool 206d uses retrieved and analyzed data, contextual annotations retrieved by tools/sub-agents from the database to generate a narrative synthesis or contextualized report based on a user's query. It generates natural language summaries and structured reports using the reasoning engine 602, summary composer 604, context integrator 606, and relevance filter 608.

FIG. 7 depicts the investigation tool 206e, which performs event-specific investigations based on internal or external triggers. The investigation tool 206e includes a trigger monitor 702, a subject tracker 704, a report generator 706, and a pattern recognizer 708.

The planning agent 204 selects the investigation tool 206e when the input interface includes commands or triggers that imply active monitoring or anomaly detection. For example, “Investigate every person wearing a hoodie and carrying a gun,” “I want an investigation report of every person that spends more than 10 minutes in the scene,” or a 911 call trigger prompts the system to track entities and compile structured reports. The trigger monitor 702 listens for predefined conditions, which may be configured via natural language commands or external signals such as emergency calls or document uploads. The subject tracker 704 follows entities across frames using object IDs and spatial coordinates. The report generator 706 compiles findings into structured reports. The pattern recognizer 708 identifies recurring behaviors or anomalies.

Thus, the investigation tool 206e is activated in response to a query involving internal or external trigger conditions. It receives entity tracking data, spatial and temporal coordinates, and trigger definitions. It generates structured investigation reports, movement trajectories, and pattern recognition results using the trigger monitor 702, subject tracker 704, report generator 706, and pattern recognizer 708.

FIG. 8 shows the document-aware QA tool 206f, which processes external documents and images to enhance query context. The document-aware QA tool 206f includes an OCR processor 802, a vision LLM 804, a context builder 806, and a semantic linker 808.

The planning agent 204 activates the document-aware QA tool 206f when the input interface includes document uploads or image files that provide additional context. For example, when a user uploads an accident report describing a collision involving two vehicles and individuals, the tool extracts contextual details such as vehicle descriptions, time, location, and participant attributes. The OCR processor 802 extracts text from uploaded files. The vision LLM 804 interprets visual content and generates semantic descriptions. The context builder 806 uses information from the uploaded document or documents to build a more complete understanding of the content of the document or documents. The semantic linker 808 aligns document content with the database schema and detailed frame document, enabling queries such as “Show persons involved in the incident” to be interpreted with reference to the uploaded report.

The document-aware QA tool 206f processes uploaded documents and images in view of a user's query. It receives external content via the input interface, extracts text using the OCR processor 802, interprets visual content via the vision LLM 804, and makes contextual enhancements available to the planning agent for tool planning; tools/sub-agents use the enhanced context to query the database as needed using the context builder 806 and semantic linker 808.

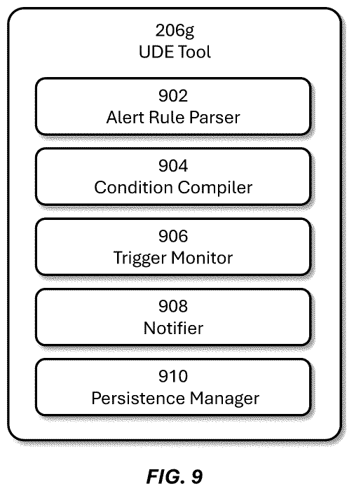

FIG. 9 illustrates a user-defined alert (UDE) tool 206g, which is configured to register alert rules and monitor streaming updates and database inserts for rule matches. The UDE tool 206g includes an alert rule parser 902, a condition compiler 904, a trigger monitor 906, a notifier 908, and a persistence manager 910. The input interface 202 receives user requests such as “set an alert on all persons driving a motorcycle without helmets,” and the planning agent 204 interprets the request using the frame document schema and activates the UDE tool 206g to register and manage the alert rule. The alert rule parser 902 converts the natural-language request into a structured alert specification that references schema fields (e.g., detection/classification labels, event types, segmentation regions, proximity/duration constraints) and may include hybrid conditions that combine structured filters with vector similarity criteria over image embeddings (e.g., visual attributes or logos). The condition compiler 904 translates the alert specification into an executable rule definition, including temporal windows (e.g., “for more than 15 seconds”), spatial relations (e.g., “in a bus lane,” “person next to car with advertisement”), thresholds, and suppression/de-duplication options. The trigger monitor 906 subscribes to events produced by tools/sub-agents and to database write streams; for each incoming record, it evaluates the compiled rule by first applying structured filters and then, where specified, executing vector similarity checks over the relevant embeddings (e.g., object crops) to confirm visual concepts. Upon a match, the notifier 908 assembles an alert payload comprising metadata, time spans, matched conditions, and references to the corresponding detailed frame documents retrieved by the Search tool and forwards the payload to the response generator 208 for delivery. The persistence manager 910 stores alert rules, versions, and run-time state (e.g., active/paused, last-fired timestamps, suppression intervals), exposes identifiers for rule management (activate, pause, resume, cancel) via the planning agent 204, and ensures rule evaluation remains aligned with the current frame document schema. Thus, the UDE tool 206g registers user-defined alert rules from natural-language inputs, continuously evaluates streaming and stored data using hybrid (structured+vector) conditions and temporal/spatial constraints, and produces actionable alerts for downstream presentation.

Returning to FIG. 2, the response generator 208 compiles results/outputs from the activated tools into a coherent response. The response generator includes an image/video output module 208a, a text output module 208b, and a document exporter 208c. These modules are configured to generate annotated frames, video segments, natural language summaries, statistical results, and downloadable documents using content from one or any combination of the tools/agents described above. Responses can be generated in formats such as PDF, DOCX, HTML, CSV, JSON, and the like.

Each of the following scenarios begins with a live video stream processed by the scene understanding module, which generates a detailed frame document containing semantic annotations that are stored in a database. The reasoning orchestrator forwards each query from the input interface; the planning agent interprets the query using frame document schema and selects appropriate tools/sub-agents; the tools/sub-agents access the database to retrieve and process information from one or more detailed frame documents; and the response generator compiles the final output.

In one scenario, a traffic camera provides a live video feed to the scene understanding module, which detects vehicles, traffic signals, weather conditions, and violations. A detailed frame document is generated containing continuously updated contextualized scene information that includes, e.g., vehicle color, violation type, timestamp, and weather annotations. A user submits a query via the input interface requesting “All red cars that ran a red light in the rain last week.” The input interface receives a user's query and forwards it to the planning agent. The planning agent parses the query's intent and constraints in view of the frame document schema and selects the appropriate tools/sub-agents. Based on this analysis, the planning agent determines that the search tool is appropriate and activates it. The search tool uses its query parser and schema interpreter to convert the natural language query into a structured database query, and its retrieval engine queries the frame documents database. The retrieval engine accesses detailed frame documents in the database and filters results based on vehicle color, violation type, timestamp, and weather. The result formatter returns image paths, video segments, and metadata to the response generator. The response generator then compiles the results using the image/video output module and document exporter, producing a file listing license plates and timestamps along with annotated video clips showing each violation.

In another scenario, a public surveillance feed is processed by the scene understanding module, which identifies human subjects, tracks movement, and detects physical altercations. The detailed frame document includes annotations for duration, number of participants, and location. A user submits a query via the input interface requesting “Summarize all fighting violations involving more than two people lasting longer than 30 seconds.” The input interface receives the query and forwards it to the planning agent, which interprets the query and then activates both the investigation tool and the summarization tool. The investigation tool uses its trigger monitor to identify relevant events, its subject tracker to follow individuals across frames, and its report generator to compile structured incident data. The summarization tool uses its reasoning engine to determine what details to include, its summary composer to generate natural language output, and its relevance filter to ensure the report focuses on qualifying incidents. The response generator then uses the text output module to produce a detailed PDF summary and the image/video output module to include annotated frames showing the altercations.

In a third scenario, a user uploads a police report via the input interface describing a hit-and-run involving two vehicles and a suspect wearing a white tank top. The planning agent activates the document-aware QA tool. The OCR processor extracts text from the report, and the vision LLM interprets any embedded images. The context builder injects extracted details—vehicle descriptions, time, location, and suspect appearance—into memory accessible to the planning agent. The planning agent uses this context to interpret a follow-up query: “Show persons involved in the incident.” The planning agent activates the search tool to locate matching video segments. The retrieval engine filters for individuals matching the suspect description near the reported location and time. The response generator compiles the results into a DOCX file using the document exporter, including annotated frames, vehicle trajectories, and a structured incident summary.

In a fourth scenario, the scene understanding module continuously processes video feeds from a busy intersection, generating detailed frame documents with daily violation counts and types. A user submits a query via the input interface requesting “Create a graph showing the trend of the number of violations each day for the last 1 month.” The reasoning orchestrator forwards the query to the planning agent, which activates the analysis tool to compute daily violation counts using its temporal filter and statistical processor. The planning agent then activates the graph generation tool to visualize the results. The plotting engine renders the graph, and the labeling module annotates it with dates and counts. The response generator returns a PNG image of the graph via the image/video output module and includes a short summary via the text output module.

In a fifth scenario, a user sets an alert via the input interface for trucks with dented bumpers. The scene understanding module monitors incoming video and updates the detailed frame document with vehicle damage annotations. The reasoning orchestrator registers the alert (e.g., as a user input query via the input interface) and configures the planning agent to monitor for matching conditions. When a match is detected, the planning agent activates the search tool to retrieve relevant footage and metadata. The response generator sends an alert to the user via the image/video output module, including annotated video and a summary of the detection.

The disclosed system introduces a number of technical innovations that collectively enhance its performance, adaptability, and operational scope. At its core, the architecture leverages an adaptive key frame selection mechanism that intelligently reduces the volume of video data subjected to deep analysis. By prioritizing frames based on, e.g., temporal sampling, object motion, and scene activity density, the system maintains semantic fidelity while optimizing computational efficiency. This selective approach is further supported by a frame preprocessing module that applies dynamic enhancement techniques—including de-noising, de-blurring, exposure correction, super-resolution, and lens distortion correction—tailored to the characteristics of each frame and the available system resources.

The scene understanding module employs a three-tiered pipeline that integrates object-level analysis, semantic vectorization via a Vision-Language Model (VLM), and contextual synthesis through a Vision Large Language Model (VLLM). These models may be fine-tuned for specific operational domains, allowing the system to generate highly contextualized scene descriptions that reflect domain-specific terminology, object classifications, and behavioral patterns. This layered processing enables the system to interpret complex scenes with high resolution and semantic depth, supporting nuanced query resolution and event detection.

The smart surveillance system of the inventive subject matter is designed with modularity and flexibility in mind, and it is designed specifically to function in association with one or more detailed frame documents generated by a scene understanding module. The input interface, planning agent, and specialized tools/sub-agents operate in concert to dynamically activate processing pathways based on query type, system load, and contextual constraints. The planning agent is capable of sequencing tool activation within defined computational and latency budgets, ensuring real-time responsiveness across both cloud-based and edge deployments. The system supports both continuous inference—where all incoming key frames are processed in real time—and ad hoc inference, which allows selective analysis triggered by specific conditions or user-defined priorities.

Multimodal input and output capabilities further distinguish the system. Users may interact via natural language queries, document uploads, or external signals, and receive responses in the form of annotated video segments, structured metadata, graphical visualizations, and downloadable reports in formats such as PDF, DOCX, CSV, and JSON. This multimodal framework enhances accessibility and facilitates integration with external platforms, including law enforcement databases, traffic control systems, and incident management tools.

The system also supports multi-modal trigger monitoring, enabling simultaneous detection of internal anomalies—such as unusual behavior in video feeds—and external events, including emergency calls or uploaded reports. The planning agent, which can be powered by a fine-tuned large language model, can generate and refine investigation plans in response to these triggers, adapting its strategy in real time and optimizing resource allocation across investigative cycles. Based on the outcomes of these investigations, the system may proactively recommend context-specific alerts and configure them automatically, reducing manual oversight and improving surveillance coverage.

Thus, specific systems and methods of intelligent video analysis and multimodal response generation have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of orchestrating multimodal query resolution for queries about video content that is processed in real-time, the method comprising the steps of:
receiving a query at an input interface;
determining, by a planning agent, one or more tools/sub-agents to activate based on the query and schema of a detailed frame document;
wherein the detailed frame document comprises structured and contextualized information about the video content and is continuously updated as the video content is processed in real-time;
wherein the one or more tools/sub-agents are activated based on the query and on a specialization of each activated tool/sub-agent;
accessing the detailed frame document by the one or more tools/sub-agents to generate outputs based on the query;
receiving, by a response generator, outputs from the activated tools/sub-agents; and
generating, by the response generator, a response to the query based on the outputs from the one or more tools/sub-agents.

2. The method of claim 1, wherein the input interface comprises a graphical user interface, an API endpoint, or a natural language processing module.

3. The method of claim 1, wherein the detailed frame document includes structured metadata, semantic embeddings, and contextual annotations derived from key frames of the video content.

4. The method of claim 1, wherein the planning agent sequences activation of the one or more tools/sub-agents based on system resource availability or scene complexity.

5. The method of claim 1, wherein the one or more tools/sub-agents comprise at least one of: a search tool, an analysis tool, a graph generation tool, a summarization tool, an investigation tool, or a document-aware question answering tool.

6. The method of claim 1, wherein the response generator is configured to generate responses in multiple formats, including annotated video segments, graphical visualizations, and downloadable reports.

7. The method of claim 1, wherein the detailed frame document is generated by a scene understanding module that selects key frames based on temporal sampling, object motion analysis, or scene activity density.

8. The method of claim 1, wherein the planning agent adapts tool activation in real-time based on intermediate outputs or evolving scene context.

9. A method of orchestrating multimodal query resolution for video content processed in real-time, the method comprising the steps of:
receiving, by a reasoning orchestrator, a natural language query at an input interface;
interpreting, by the reasoning orchestrator, the natural language query in the context of detailed frame document schema;
generating, by the reasoning orchestrator, a structured investigation plan that identifies one or more specialized tools or sub-agents to activate based on the query and the detailed frame document;
activating, by the reasoning orchestrator, the one or more specialized tools or sub-agents according to the structured investigation plan;
receiving, by the reasoning orchestrator, outputs from the activated tools or sub-agents; and
generating, by the reasoning orchestrator, a response to the query based on the outputs.

10. The method of claim 9, wherein the structured investigation plan is dynamically adapted by the reasoning orchestrator based on intermediate outputs from the specialized tools or sub-agents.

11. The method of claim 9, wherein the reasoning orchestrator maintains a contextual memory of prior queries to refine selection of the specialized tools or sub-agents.

12. The method of claim 9, wherein the response generated by the reasoning orchestrator comprises at least one of: annotated video, graphical visualizations, or downloadable reports.

13. The method of claim 9, wherein the detailed frame document comprises structured metadata, semantic embeddings, and contextual annotations derived from key frames of the video content.

14. The method of claim 9, wherein the structured investigation plan is constructed using at least one of: a decision tree, a rule-based template, or logic generated by a large language model.

15. The method of claim 9, wherein the specialized tools or sub-agents comprise at least one of: a search tool, an analysis tool, a graph generation tool, a summarization tool, an investigation tool, or a document-aware question answering tool.

16. A method of orchestrating multimodal query resolution for real-time video content, the method comprising the steps of:
receiving, by a reasoning orchestrator, a query or an external trigger at an input interface;
interpreting, by the reasoning orchestrator, the query or trigger in the context of a continuously updated detailed frame document comprising structured metadata, semantic embeddings, and contextual annotations;
determining, by the reasoning orchestrator, one or more specialized tools or sub-agents to activate based on the query or trigger and the contents of the detailed frame document;
activating, by the reasoning orchestrator, the one or more specialized tools or sub-agents;
receiving, by the reasoning orchestrator, outputs from the activated tools or sub-agents; and
generating, by the reasoning orchestrator, a multimodal response to the query or trigger based on the outputs.

17. The method of claim 16, wherein the external trigger comprises at least one of an anomaly detected in a video feed, an emergency call, and a document upload.

18. The method of claim 16, wherein the multimodal response generated by the reasoning orchestrator includes an alert generated in response to the trigger.

19. The method of claim 16, wherein the reasoning orchestrator adapts activation of the specialized tools or sub-agents in real-time based on evolving scene context.

20. The method of claim 16, wherein the specialized tools or sub-agents include a document-aware question answering tool configured to process external documents or images uploaded via the input interface.
